(19) United States
(12) Patent Application Publication
(10) Pub. No.: US 2024/0370828 A1
(43) Pub. Date: Nov. 7, 2024

(54) METHOD AND SYSTEM FOR SHARING COLLABORATIVE DIGITAL MODELS

(71) Applicant: RAYTHEON TECHNOLOGIES CORPORATION, Farmington, CT (US)

(72) Inventors: Stalin Arockiadoss Michael, Irving, TX (US); Andrew Klaassen, Manchester, CT (US); James McIntyre, Los Angeles, CA (US)

(21) Appl. No.: 18/143,772

(22) Filed: May 5, 2023

(51) Int. Cl. G06Q 10/10

(52) U.S. Cl. CPC G06Q 10/103

(57) ABSTRACT

An example method includes storing in memory a digital model that includes a plurality of subsystems representing different functions of a system, where each subsystem includes model elements, and design responsibility for different ones of the model elements is assigned to different engineering teams. The method includes receiving, from a user not part of a first engineering team, a request to access a particular model element of a particular subsystem, wherein design responsibility for the particular model element is assigned to the first engineering team, and the particular model element includes at least one redaction implemented according to a security policy of the first engineering team. The method includes performing at least one of facilitating delivery of a redacted version of the particular model element to the user that includes the at least one redaction, and facilitating delivery of an unredacted version of the particular model element to the user.

### BACKGROUND

This application relates to digital models, and more particularly to sharing elements of digital models in a collaborative design environment.

For complex collaborative design projects that utilize a digital model of a system, it is known to divide design responsibilities for various subsystems representing different functions of the system among different engineering teams. Although contributing engineering teams may be collaborators for the collaborative engineering model, the teams may otherwise be competitors and wish to limit the extent to which other engineering teams are able to access sensitive information in their subsystems.

### SUMMARY

An example method of sharing a digital model includes storing in memory at least metadata of a digital model of a system, wherein the digital model includes a plurality of discrete subsystems representing different functions of the system, each subsystem including a plurality of discrete model elements, and design responsibility for different ones of the model elements is assigned to different ones of a plurality of engineering teams. The method includes receiving, from a user that is not part of a first engineering team of the plurality of engineering teams, a request to access a particular model element of a particular subsystem, wherein design responsibility for the particular model element is assigned to the first engineering team, and the particular model element includes at least one redaction implemented according to a security policy of the first engineering team. The method includes performing at least one of: based on the request lacking a redaction token corresponding to the at least one redaction, facilitating delivery of a redacted version of the particular model element to the user that includes the at least one redaction; and based on the request including the redaction token, facilitating delivery of an unredacted version of the particular model element to the user.

Another example of the above described method includes utilizing a token validation algorithm to determine whether the redaction token is valid or invalid. In this example, the facilitating delivery of the unredacted version of the particular model element is only performed if the token validation algorithm indicates that the redaction token is valid.

Another example of any of the above described methods includes receiving, from an administrative user associated with the first engineering team, an indication of a plurality of discrete digital redactions that correspond to different model elements of the particular subsystem, and associating different redaction tokens with each of the discrete redactions.

In another example of any of the above described methods, the utilizing the token validation algorithm includes comparing the received redaction token, or a value derived from the received redaction token, with a master redaction token corresponding to the at least one redaction, or a value derived from the master redaction token, and determining whether the received redaction token is validated based on the comparison.

Another example of any of the above described methods includes receiving a request from the user to access an additional model element of the particular subsystem that is non-redacted, and facilitating delivery of the additional model element without requiring receipt of a redaction token.

In another example of any of the above described methods, each engineering team has one or more first security requirements that must be fulfilled to access its model elements, and the facilitating steps are further based on the request from the user fulfilling the one or more security requirements of the first engineering team.

In another example of any of the above described methods, the one or more security requirements of the first engineering team include one or more first security requirements and one or more second security requirements that differ from the one or more first security requirements, compliance of the request with the one or more first security requirements of the first engineering team is a prerequisite for delivery of the redacted version and the unredacted version of the particular model element, and compliance of the request with the one or more second security requirements of the first engineering team is a prerequisite for delivery of the unredacted version, but not the redacted version, of the particular model element.

In another example of any of the above described methods, the method includes a security server performs the storing step, receiving step, and at least one of the facilitating delivery steps. In this example, the method includes the security server validating the redaction token, and based on a successful validation, sending an indication of the request to a security client of the first engineering team to facilitate determination, by the security client, of whether the request fulfills the one or more second security requirements.

In another example any of the above described methods, the one or more security requirements include at least one of a requirement that an IP address of a computing device that the request received from is not a blacklisted IP address, a requirement that the computing device is not located in an unauthorized geographic territory, and a requirement that a static device identifier of the computing device is not blacklisted.

In another example of any of the above described methods, the one or more security requirements include at least one of a requirement that the user is not part of a user group that the first engineering team has prohibited from accessing unredacted model elements of the first engineering team, and a requirement that the redaction token has not been used more than a predefined number of permitted times.

Another example of any of the above described methods includes rejecting a request for an unredacted version of the particular model element based on the particular model element being flagged for inclusion in a patent application that has not yet been filed.

In another example of any of the above described methods of sharing a digital model a security server performs the storing step, receiving step, and at least one of the facilitating delivery steps, the facilitating delivery of the redacted version of the particular model element includes the security server obtaining the redacted version from its own storage, and sending the redacted version to the user, and the facilitating delivery of the unredacted version of the particular model element to the user includes the security server obtaining the unredacted version from the first engineering team in response to the request, and sending the unredacted version to the user after it is received from the first engineering team.

In one example embodiment a system for sharing a digital model, the system includes a security server including processing circuitry operatively connected to memory and configured to store in the memory at least metadata of a digital model of a system, wherein the digital model includes a plurality of discrete subsystems representing different functions of the system, each subsystem includes a plurality of discrete model elements, and design responsibility for different ones of the model elements is assigned to different ones of a plurality of engineering teams. The processing circuitry is configured to receive, from a user that is not part of a first engineering team of the plurality of the engineering teams, a request to access a particular model element of a particular subsystem managed by the first of the engineering teams, wherein the particular model element includes at least one digital redaction implemented according to a security policy of the first of the engineering teams. The processing circuitry is configured to perform at least one of: based on the request lacking a redaction token corresponding to the at least one redaction, facilitate delivery of a redacted version of the particular model element to the user that includes the at least one redaction; and based on the request including the redaction token, facilitate delivery of an unredacted version of the particular model element to the user.

In another example of the above described system, the processing circuitry is configured to utilize a token validation algorithm to determine whether the redaction token is valid or invalid, and only facilitate delivery of the unredacted version of the particular model element if the token validation algorithm indicates that the redaction token is valid.

In another example of any of the above described systems, the processing circuitry is configured to receive, from an administrative user associated with the first engineering team, an indication of a plurality of discrete redactions that correspond to different model elements of the particular subsystem, and associate different redaction tokens with each of the discrete redactions.

In another example of any of the above described systems, the processing circuitry is configured to receive a request from the user to access an additional model element of the particular subsystem that is non-redacted, and facilitate delivery of the additional model element without requiring receipt of a redaction token.

In another example of any of the above described systems, the first engineering team has one or more first security requirements and one or more second security requirements that differ from the one or more first security requirements, compliance of the request with one or more first security requirements of the first engineering team is a prerequisite for the security server to facilitate delivery of the redacted version and the unredacted version of the particular model element, and compliance of the request with one or more second security requirements of the first engineering team is a prerequisite for delivery of the unredacted version, but not the redacted version, of the particular model element.

In another example of any of the above described systems, each of the engineering teams has a respective security client, and the processing circuitry is configured determine whether the request complies with the one or more first security requirements independently of the security client of the first engineering team. In this example, to facilitate delivery of the unredacted version of the particular model element, the processing circuitry is configured to send an indication of the request to the security client of the first engineering team for determination, by the security client of the first engineering team, of whether the request fulfills the one or more second security requirements.

In another example of any of the above described systems, the first security requirements or second security requirements include at least one of: a requirement that an IP address of a computing device that the request received from is not a blacklisted IP address, a requirement that the computing device is not located in an unauthorized geographic territory, a requirement that a static device identifier of the computing device is not blacklisted, a requirement that the user is not part of a user group that the first engineering team has prohibited from accessing unredacted model elements of the first engineering team, a requirement that the redaction token has not been used more than a predefined number of permitted times, and a requirement that the particular model element is not flagged for inclusion in a patent application that has not yet been filed.

In another example of any of the above described systems, for each engineering team, the security client is configured to act as a broker by communicating with the server to send and receive requests for model elements, communicating with the server to sending and receiving model elements, and storing third party tokens for accessing redacted versions of model elements of others of the engineering teams.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of an example collaborative design system.

FIG. 2 is a schematic view of example functional elements utilized by an engineering team in the system of FIG. 1.

FIG. 3 schematically illustrates an example digital model and its various subsystems.

FIG. 4 illustrates an example token allocation for the digital model of FIG. 3.

FIG. 5 illustrates another example token allocation for the digital model of FIG. 3.

FIG. 6 illustrates an example method of sharing a collaborative design model in the system of FIG. 1.

FIG. 7 illustrates an example signaling diagram that may be used to implement aspects of the method of FIG. 6.

### DETAILED DESCRIPTION

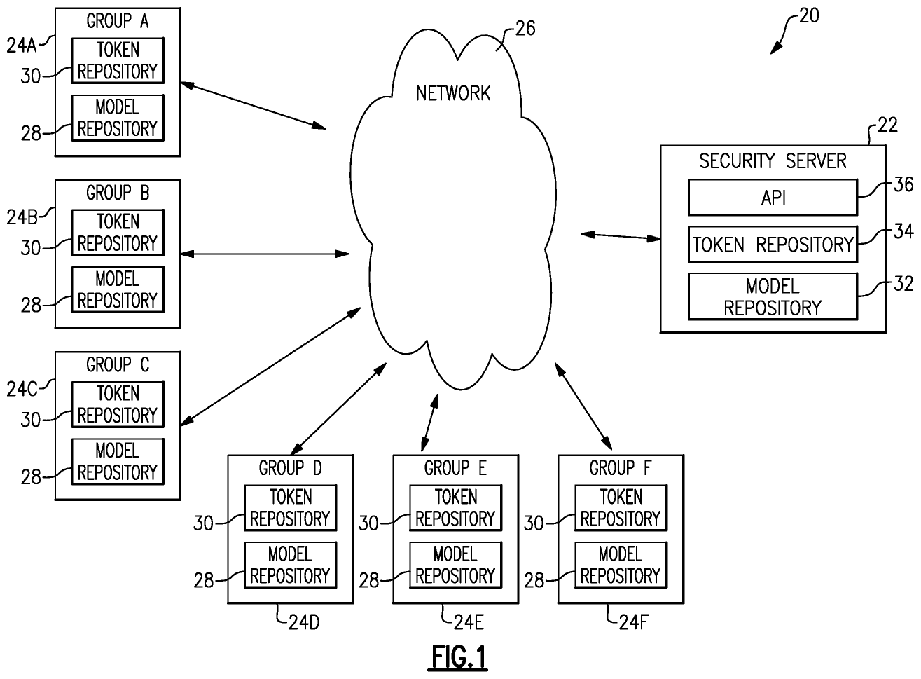

FIG. 1 is a schematic view of an example collaborative design system 20 that includes a security server 22. The security server 22 provides a software platform for facilitating sharing and collaboration for a digital model of a system (e.g., a drone, aircraft, or other system with various functional components). The software platform provided at least in part by the security server 22 facilitates collaboration on a digital model between a plurality of groups 24A-F through one or more networks 26 (e.g., wide area networks, such as the Internet, or one or more local area networks).

Each group 24 has a model repository 28 that that stores model elements of the digital model and each group 24 also has a token repository 30 that may be used to store tokens for accessing redacted versions of model elements of others of the groups 24.

The security server 22 also has its own model repository 32 that stores model elements, and a token repository 34 that stores tokens and/or values derived from tokens (e.g., hashing values derived from tokens). The groups 24 may include engineering teams that design portions of the digital model and also non-designer entities, such as a customer that has commissioned design of the digital model. The security server 22 also provides an application programming interface (API) as part of its software platform, for communicating with the various groups 24A-F to selectively provide access to various model elements of one or more digital models.

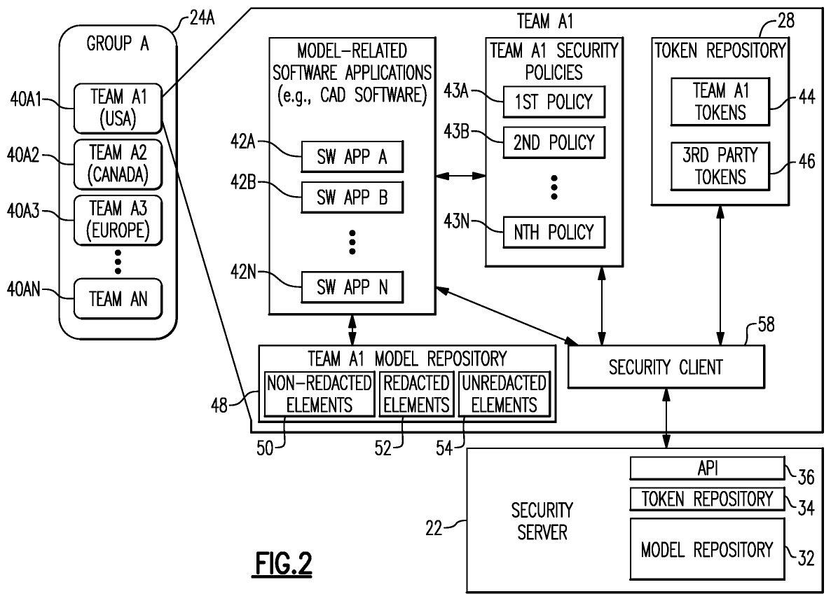

FIG. 2 is a schematic view of example functional elements utilized by an engineering Team A1 (numeral 40A1) from group 24A of FIG. 1. In the example of FIG. 2, group 24A includes a plurality of Teams 40A-N that are geographically distributed, with team 40A being in the United States, Team B (numeral 40B) being in Canada, and team 40C being in Europe.

As shown in FIG. 2, Team A utilizes a plurality of digital model-related software applications 42A-N, which may include computer aided design (CAD) software, software for preparing circuit schematics, and/or other software (e.g., for providing text-based description of model components, power requirements, dimensions, materials, etc.). As used herein, an Nth item (e.g., element 42N) generally represents a plurality of elements, and not a particular number of elements. Thus, the value of N for element 42N is not necessarily the same as the value of N for other reference numerals (e.g., 43N).

Team A1 has a plurality of security policies 43A-N that provide restrictions on what model elements can be shared outside of the team (e.g., with other teams 40 in group 24A and/or with other groups 24B-F). For example, one of the security policies 43 of Team A1 may restrict the ability of Team A1 to share portions of its digital model contributions outside of the USA (e.g., due to International Traffic in Arms Regulations).

Team A1 has a model repository 48 that includes a plurality of model elements of a digital model, including non-redacted model elements 50, redacted model elements 52, and unredacted model elements 54. As used herein, a “non-redacted” model element is one which has no associated redaction requirement and therefore no associated redacted version. A redacted model element 52 is one that has been at least partially redacted, and an unredacted model element 54 is an unredacted version of a model element that has a redacted counterpart, and that an associated redaction requirement. A redaction to a model element may include a number of things, such as blacking out or hiding text or graphical elements, scrambling data (e.g., strings or numeric values), obscuring details (e.g., by converting a complex geometric shape into a simplified version of the geometric shape, etc.) in order to withhold some detail about the model element that is redacted.

The token repository of Team A1 includes its own tokens 44, used for determining whether those outside of Team A1 can access Team A1's unredacted model elements 54, and third party tokens 46 used for determining whether Team A1 can access unredacted model elements of those outside of Team A1.

A security client 58 is a client of the security server 22 and facilitates communication between Team A1 and the security server 22. The security client 58 utilizes the API 36 of the security server 22 for various tasks, such as, for example, requesting model elements, requesting redaction tokens, receiving requests for unredacted model elements 54, etc.

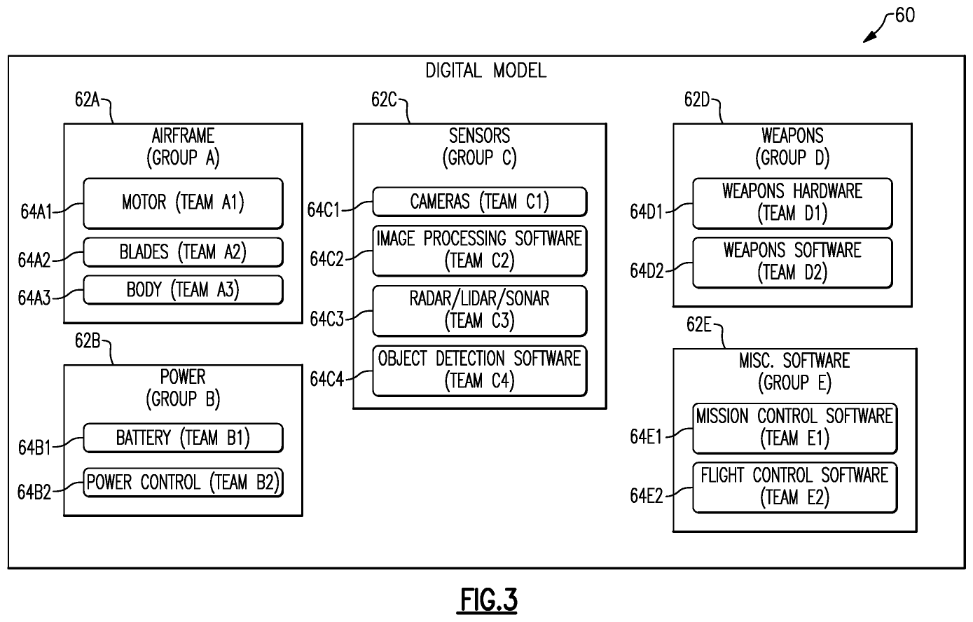

FIG. 3 schematically illustrates an example digital model 60 for a system, which in the example of FIG. 3 is a drone. The digital model 60 includes a plurality of subsystems 62A-E, which each represent different functions of the drone. Each subsystem 62 includes a plurality of subsidiary base models 64 that are managed by separate teams 40. Subsystem 62A (for which design responsibility is assigned to different teams of Group A) relates to an airframe subsystem of the drone. Subsystem 62B (for which design responsibility is assigned to various teams of Group B) relates to a power system of the drone. Subsystem 62C (for which design responsibility is assigned to various teams of Group C) relates to sensors of the drone. Subsystem 62D (for which design responsibility is assigned to various teams of Group D) relates to weapons of the drone. Subsystem 62E (for which design responsibility is assigned to various teams of Group E) relates to miscellaneous software of the drone.

As shown, Airframe subsystem 62A includes a motor base model 64A1 for which Team A1 is responsible, a blades base model 64A2 for turbine blades of the drone for which Team A2 is responsible, and a body base model 64A3 for a fuselage of the drone for which Team A3 is responsible.

Power subsystem 62B includes a battery base model 64B1 for which Team B1 is responsible, and a power control base model 64B2 for which Team B2 is responsible.

Sensor subsystem 62C includes a cameras base model 64C1 for which Team C1 is responsible, an image processing software base model 64C2 for which Team C2 is responsible, a radar/lidar/sonar base model 64C3 for which Team C3 is responsible, and an object detection software base model 64C4 for which Team C4 is responsible.

Weapons subsystem 62D includes a weapons hardware base model 64D1 for which Team D1 is responsible, and a weapons software base model 64D2 for which Team D2 is responsible.

Miscellaneous software subsystem 62E includes a mission control software base model 64E1 for which Team E1 is responsible, and a flight control software base model 64E2 for which Team E2 is responsible.

Although FIG. 3 is only a non-limiting example, it clearly shows how the design model 60 can have various subsystems 62, each having constituent base models 64 with responsibility distributed across many groups 24 and teams 40.

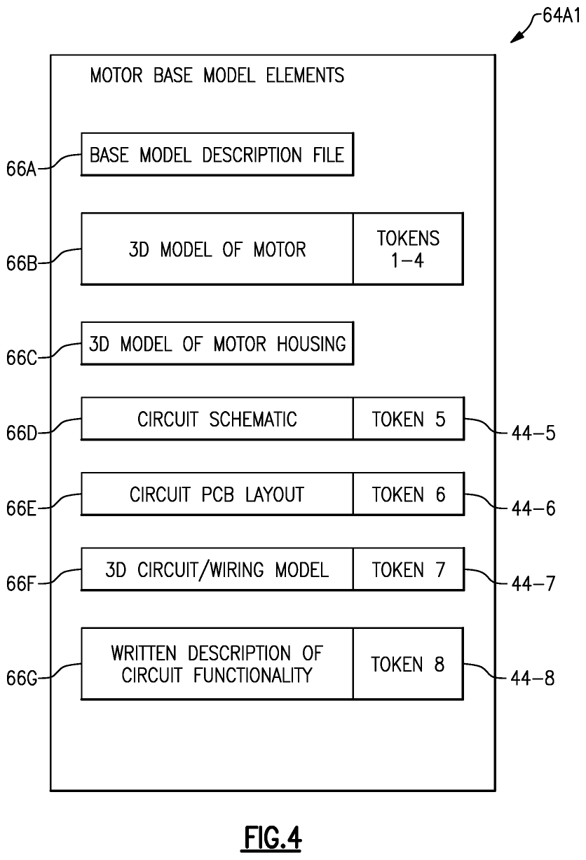

FIG. 4 illustrates a plurality of example model elements 66A-G of the base model 64A1 and an allocation of redaction tokens 44-1 to 44-8 to various ones of the model elements 66A-G. As shown in FIG. 4, the motor base model 64A1 includes the following model elements: base model description file 66A, 3D model of motor 66B, 3D model of motor housing 66C, circuit schematic 66D, circuit PCB layout 66E, 3D circuit/wiring model 66F, and written description of circuit functionality 66G.

Each of the model elements 66B, 66D, 66E, 66F, and 66G are at least partially redacted and have corresponding tokens 44-1 through 44-8 assigned to those redactions. As discussed above, a redaction to a model element may include a number of things, such as blacking out or hiding text or graphical elements, scrambling data (e.g., strings or numeric values), obscuring details (e.g., by converting a complex geometric shape into a simplified version of the geometric shape, etc.) in order to withhold some detail about the model element that is redacted.

Redaction token 44-5 is associated with a redaction to circuit schematic 66D, redaction token 44-6 is associated with a redaction to circuit PCB layout 66E, redaction token 44-7 is associated with a redaction to 3D circuit/wiring model 66F

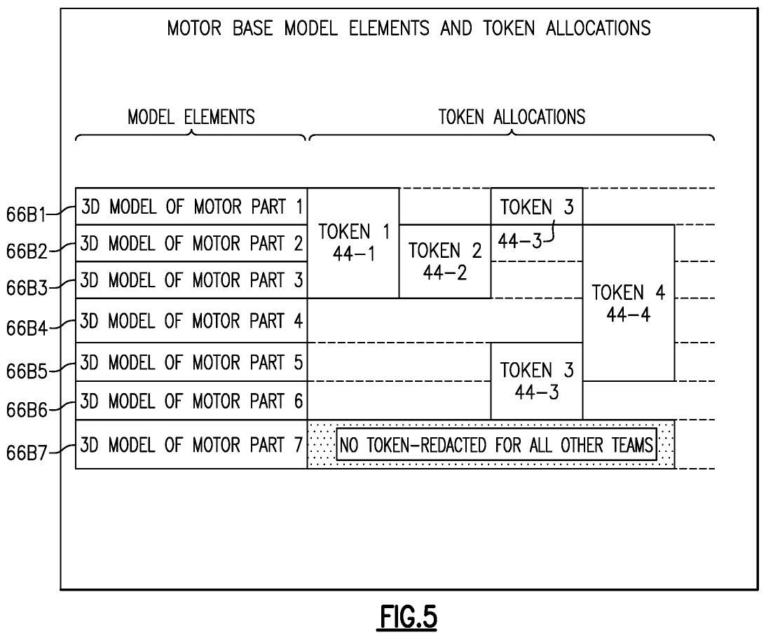

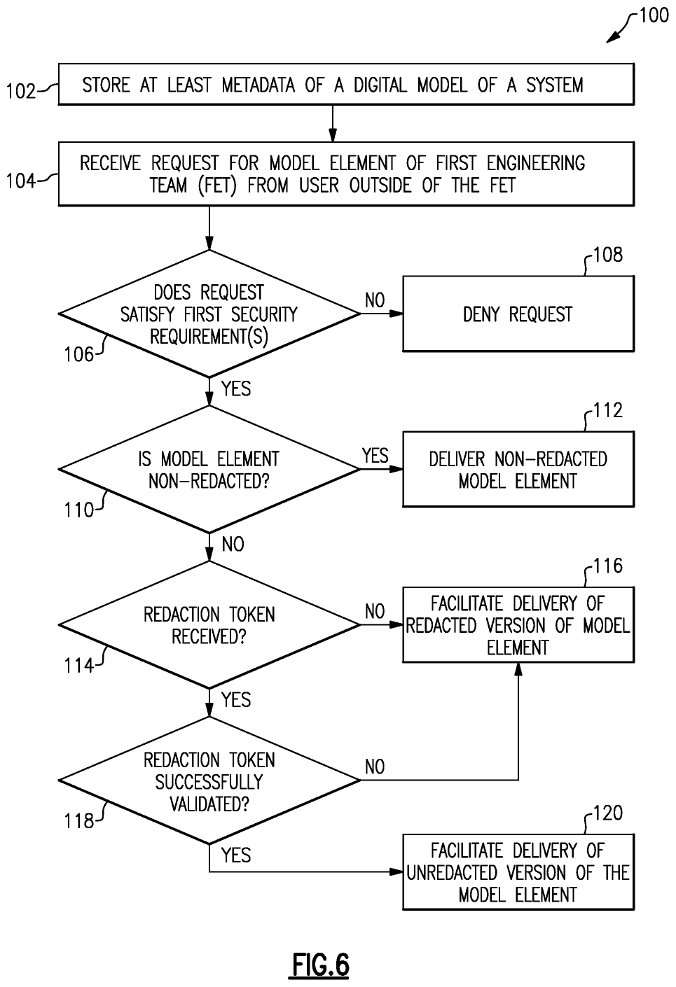

FIG. 5 illustrates a token allocation for redactions to the 3D motor model 66B, which as shown in FIG. 6 includes a plurality of constituent model elements 66B1-66B7 for different components of the 3D model of the motor 66B. Token 1 (numeral 44-1) is used for redactions to model elements 66B1, 66B2, and 66B3. Token 2 (numeral 44-2) is used for redactions to model elements 66B2 and 66B3. Token 3 (numeral 44-3) is used for redactions to model elements 66B1, 66B5, and 66B6. Token 4 (numeral 44-4) is used for redactions to model elements 66B2 through 66B5. Element 66B7 is redacted, but has no associated redaction token because it is not shareable with anyone outside of Team A1. Different ones of the tokens 44 shown in FIG. 5 can be provided to different groups 24 and/or teams 40 in the system 20 to provide for granular control over what model elements 66 get shared in redacted form, and which groups 24 and/or teams 40 in the system 20 are able to access unredacted versions of the redacted model elements 66. Where a single model element (e.g., model element 66B2) has multiple associated redaction tokens, those tokens may be associated with the same or with different redactions to the model element 66B2.

FIG. 6 illustrates an example method 100 of sharing a digital model in the system 20 of FIG. 1, which is performed in part or in whole by the security server 22. For the discussion below, assume the “first engineering team” (“FET”) is Team A1 (numeral 64A1) (although any of the various engineering teams could be used instead).

At least metadata of a digital model 60 of a system is stored in memory (step 102). The digital model 60 includes a plurality of discrete subsystems 62 representing different functions of the system, each subsystem 62 including a plurality of discrete model elements 66, and design responsibility for different ones of the model elements 66 is assigned to different ones of a plurality of engineering teams 40.

A request for a model element of a first engineering team, which in this example discussion is Team A1, is received from a user outside of Team A1 (step 104). This may be a from another team of Group A (e.g., Team A2 or Team A3), or may be a user from another group 24, for example.

A determination is made of whether the request satisfies one or more first security requirements associated with Team A1 (step 106). In at least one example, the one or more first security requirements of step 106 are baseline security requirements that must be satisfied to have access to any model element 66 of the collaborative digital model 60, which could serve to prevent unauthorized users from accessing even redacted versions of model elements 66. If the one or more first security requirements are not satisfied (a “no” to step 106), the request is denied (step 108). Otherwise, if the one or more first security requirements are satisfied (a “yes” to step 106), a determination is made of whether the requested model element is non-redacted (step 110).

Referring to FIG. 4, the model element 66C is non-redacted because it has no associated redaction requirement, and is authorized for sharing with other teams 40 and groups 24. For such a model element, determination would be a “yes” to step 110, and the method 100 would proceed to delivering the non-redacted model element (step 112).

Otherwise, if the model element 66 is redacted (a “yes” to step 110) (like the other model elements 66A-B and 66D-G), then a determination is made of whether a redaction token has been received that corresponds to the at least one redaction (step 114). If no redaction token is received (a “no” to step 114), then delivery of a redacted version of the requested model element 66 is facilitated (step 116). Step 116 may include delivering the redacted model element 66 from the model repository 32 of the security server 22, for example.

If a redaction token is received that corresponds to the at least one redaction in conjunction with the request (a “yes” to step 114), a token validation algorithm is utilized to determine if the token can be successfully validated (step 118). The token validation algorithm involves comparing the redaction token received with the request of step 104, or a value derived from the received redaction token (e.g., a hashing value derived from the received redaction token), with a master redaction token corresponding to the at least one redaction (e.g., as described in FIGS. 4-5), or a value derived from the master redaction token (e.g., a hashing value derived from the master redaction token), and determining whether the received redaction token is validated based on the comparison.

If the redaction token is not successfully validated (a “no” to step 118), then the method proceeds to step 116, for delivery of the redacted version of the model element. Otherwise, if the redaction token validation is successful (a “yes” to step 118), then delivery of the unredacted version of the model element is facilitated (step 120). Step 120 may include the security server 22 delivering the unredacted version of the model element 66 from its own model repository 32, or may involve the security server 22 transmitting the request and potentially also the validated redaction token to Team A1 for further processing (e.g., for Team A1 to verify if the request satisfies one or more second security requirements).

As discussed above, step 102 includes storing “at least metadata” of the digital model 60 of a system is stored in memory. Some example metadata of the digital model 60 may include names of the subsystems 62, the model elements 64, and/or details of the contents of the model elements 64 (e.g., file names, file sizes, file content, etc. of the model elements 64). Step 102 may include the security server 22 storing model elements in its model repository 32 (e.g., redacted and non-redacted model elements), and relying on each group 24 to store their own unredacted model elements, for example. Alternatively, the security server 22 may omit its own model repository 32 and just obtain model elements on demand from the groups 24 as they are appropriately requested. In this case, the security server 22 would store metadata about the model elements, but not necessarily store the actual model elements themselves. The model repository 32, although shown as being part of the security server 22, may include cloud storage that is external to the security server 22.

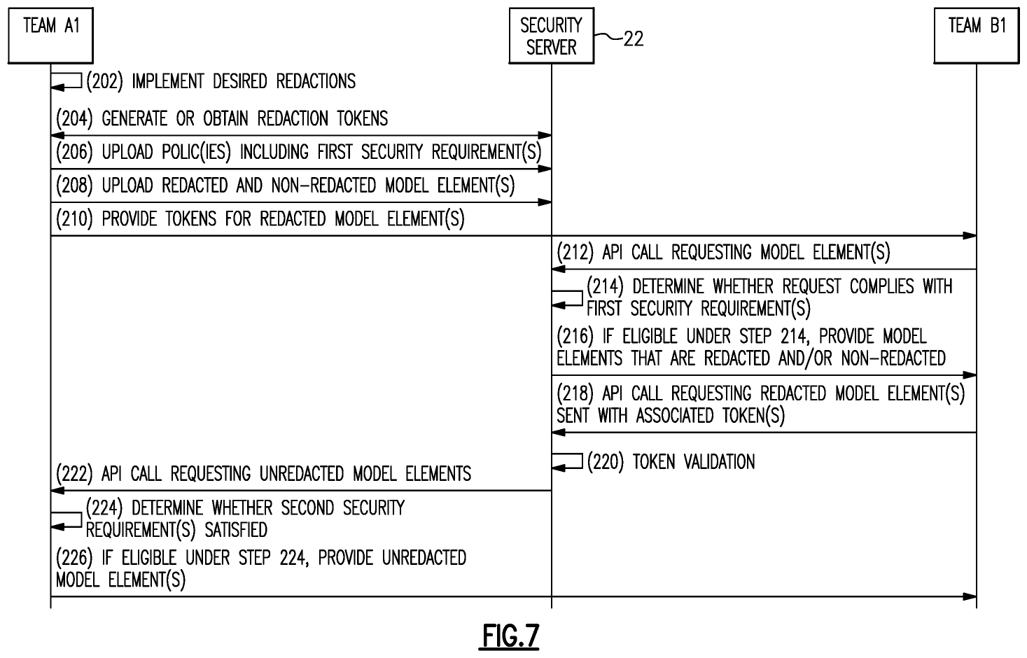

FIG. 7 illustrates an example signaling diagram that may be used to implement aspects of the method 100 of FIG. 6, and is illustrated with respect to Team A1 of Group A and Team B1 of Group B. In the example of FIG. 7, assume that Team A1 has a set of one or more first security requirements, and that compliance of a request with the one or more first security requirements is a prerequisite for a user outside of Team A1 to obtain access to any model element 66 of Team A1 (whether a non-redacted model element, redacted model element, or unredacted model element), and is also a prerequisite for the security server 22 to deliver any model element of Team A1 to the user outside of Team A1.

In the example of FIG. 7, further assume that Team A1 also has a set of one or more second security requirements that differ from the one or more first security requirements, and that compliance of a request with the one or more second security requirements is a prerequisite for a user outside of Team A1 to obtain access to an unredacted model element 66 of Team A1, and is also a prerequisite for the security server 22 to deliver any redacted model element 66 of Team A1 to the user outside of Team A1.

Referring still to FIG. 7, Team A1 (e.g., a team member or a representative of Team A1) implements one or more desired redactions (e.g., the various redactions described in FIGS. 4-5) (step 202). Redaction tokens for the one or more redactions are generated or obtained from the security server 22 (step 204). This may include Team A1 generating or obtaining its own redaction tokens and providing them to the security server 22, or the security server 22 generating the tokens on behalf of Team A1 and providing the tokens to Team A1. Thus, in at least one example the security server 22 may receive (e.g., from an administrative user associated with the first engineering team), an indication plurality of discrete digital redactions that correspond to different model elements 66 of a particular subsystem, and associate different redaction tokens with each of the discrete redactions. As used herein, the security server 22 receiving an indication of a redaction may mean the security server 22 receiving a model element that includes a redaction, for example.

Team A1 uploads one or more security policies that include the one or more first security requirements discussed above to the security server 22 (step 206), and uploads its redacted model elements 66 and, if there are any, its non-redacted model elements 66, but not its unredacted model elements 66 (step 208). Team B1 obtains a token for a redaction indicated in step 202 (step 210). This may include Team A1 sending the token to Team B1 on its own or instructing the security server 22 to send the token to Team B1, for example. Team A1's security client 58 may be used for steps 202, 204, 206, 208, and/or 210, for example.

Team B1 (e.g., a team member or representative of Team B1) uses its security client 58 to submit an API call to the API 36 requesting a particular model element (step 212).

The security server 22 determines if the request satisfies the one or more first security requirements of the one or more security policies uploaded in step 206 (step 214, which is an example implementation of step 106 of FIG. 6). If the request satisfies the one or more first security requirements, a model element is transmitted to Team B1 (step 216). If the model element 66 is non-redacted, the non-redacted model element is sent (see step 110 of FIG. 6). Otherwise, if the model element is redacted, the redacted version of the model element is sent (see step 114 of FIG. 6). In at least one example, the security server 22 does not require a redaction token for sending either a non-redacted model element or a redacted model element, but rather only requires a redaction token for sending an unredacted model element.

Team B1 uses its security client 58 to make an API call to API 36 of the security server 22 along with its associated redaction token requesting an unredacted version of the redacted model element sent in step 216 (step 218). The security server 22 utilizes a token validation algorithm to determine whether the received token is successfully validated (step 220, see also step 118 of FIG. 6).

If the redaction token is successfully validated, the security server 22 sends a request to the security client 58 of Team A1 for the unredacted model element (step 222). Team A1 (e.g., its security client 58) determines whether the request received in step 218 satisfies the one or more second security requirements of Team A1 discussed above (step 224), and if satisfied, Team A1 provides the unredacted model element(s) to Team B1, optionally through the security server 22 (step 226).

The security policies (referred to as “security requirements” above) may include a wide variety of policies, such of which may be characterized as “static” because they can be applied by the security server 22 on its own, and others which may be characterized as “dynamic” since they are more suitable to implementation by the various groups 24 participating in the system.

For example, the security requirements may be used to block any access to an entire base model 64 or one or more its model elements 66, or prevent only unredacted access to the base model 64 or one or more of its model elements 66.

Here are some example security requirements that may be used in the system 10:
Geography-based requirement limiting access based on geography (e.g., even between teams 40 of a single group 24), such as for imposing export controls (e.g., to comply with International Traffic in Arms Regulations “ITAR” regulations).
Role-based requirements that impose limitations based on role (e.g., permit manager of a given team 40 more access than a non-manager of the team 40).
Program-based requirements that impose redaction limitations based on a state of the collaborative model within a design life cycle.
Internet Protocol (IP) address requirements that either blacklist certain IP addresses, or blacklist all IP addresses not part of a whitelist from receiving unredacted model elements, or any model elements at all.
Intellectual property requirements that prohibit sharing an unredacted version of a model element until some IP protection step has been taken (e.g., trade secret agreement entered, non-disclosure agreement entered, patent application filed, etc.).
Device requirements that prohibit certain types of access (e.g., access to redacted or unredacted model elements) based on a device identifier.
License requirements that only facilitate a predefined number of uses or accesses to a particular model element (as excessive access and/or use may be indicative of abnormal activity).

Thus, in determining whether a particular request satisfies the criteria above, the security server 22 may also analyze related information about the requestor (e.g., their IP address, their device identifier, their role in the system 20, etc.)

These example security requirements, or others, may be used as part of either the one or more first security requirements applied by the security server 22 (e.g., in step 106/214) and/or the one or more second security requirements applied by the engineering team sharing its model. For some requirements, where the security server 22 is less likely to have insight into whether the requirement is fulfilled (e.g., whether a patent application has been filed yet), it may be more advantageous to include such requirements in the list of one or more second security requirements.

In at least one example, redactions are made according to a hierarchy, and corresponding redaction tokens also have a hierarchical ranking (e.g., at least a level one redaction token required to access certain model elements with a level one redaction, at least a level redaction token required to access certain model elements with a level two redaction, etc.).

In at least one example, a single redaction token may be associated with multiple redactions at different levels. Using the example of FIG. 5, in one example redaction token 1 (numeral 44-1) is a level one redaction token for accessing an unredacted version of a level one redaction, and redaction token 2 (reference numeral 44-2) is a level two redaction token for accessing the an unredacted version of the level one redaction and also of a level two redaction.

The features described above provide for engineering teams participating in a collaborative design project with a collaborative engineering model to have granular control over who can access their model elements.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method of sharing a digital model, comprising:
storing in memory at least metadata of a digital model of a system, wherein the digital model includes a plurality of discrete subsystems representing different functions of the system, each subsystem including a plurality of discrete model elements, and design responsibility for different ones of the model elements is assigned to different ones of a plurality of engineering teams;
receiving, from a user that is not part of a first engineering team of the plurality of engineering teams, a request to access a particular model element of a particular subsystem, wherein design responsibility for the particular model element is assigned to the first engineering team, and the particular model element includes at least one redaction implemented according to a security policy of the first engineering team; and
performing at least one of:
based on the request lacking a redaction token corresponding to the at least one redaction, facilitating delivery of a redacted version of the particular model element to the user that includes the at least one redaction; and
based on the request including the redaction token, facilitating delivery of an unredacted version of the particular model element to the user.

2. The method of claim 1, comprising:
utilizing a token validation algorithm to determine whether the redaction token is valid or invalid; and
said facilitating delivery of the unredacted version of the particular model element is only performed if the token validation algorithm indicates that the redaction token is valid.

3. The method of claim 2, comprising:
receiving, from an administrative user associated with the first engineering team, an indication of a plurality of discrete digital redactions that correspond to different model elements of the particular subsystem; and
associating different redaction tokens with each of the discrete redactions.

4. The method of claim 2, wherein said utilizing the token validation algorithm comprises:
comparing the received redaction token, or a value derived from the received redaction token, with a master redaction token corresponding to the at least one redaction, or a value derived from the master redaction token; and
determining whether the received redaction token is validated based on the comparison.

5. The method of claim 1, comprising:
receiving a request from the user to access an additional model element of the particular subsystem that is non-redacted; and
facilitating delivery of the additional model element without requiring receipt of a redaction token.

6. The method of claim 1, wherein:
each engineering team has one or more first security requirements that must be fulfilled to access its model elements; and
said facilitating steps are further based on the request from the user fulfilling the one or more security requirements of the first engineering team.

7. The method of claim 6, wherein:
the one or more security requirements of the first engineering team include one or more first security requirements and one or more second security requirements that differ from the one or more first security requirements;
compliance of the request with the one or more first security requirements of the first engineering team is a prerequisite for delivery of the redacted version and the unredacted version of the particular model element; and
compliance of the request with the one or more second security requirements of the first engineering team is a prerequisite for delivery of the unredacted version, but not the redacted version, of the particular model element.

8. The method of claim 7, wherein the method includes:
a security server performs said storing step, receiving step, and at least one of the facilitating delivery steps;
the method includes the security server validating the redaction token, and based on a successful validation, sending an indication of the request to a security client of the first engineering team to facilitate determination, by the security client, of whether the request fulfills the one or more second security requirements.

9. The method of claim 6, wherein the one or more security requirements include at least one of:
a requirement that an IP address of a computing device that the request received from is not a blacklisted IP address;
a requirement that the computing device is not located in an unauthorized geographic territory; and
a requirement that a static device identifier of the computing device is not blacklisted.

10. The method of claim 6, wherein the one or more security requirements include at least one of:
a requirement that the user is not part of a user group that the first engineering team has prohibited from accessing unredacted model elements of the first engineering team; and
a requirement that the redaction token has not been used more than a predefined number of permitted times.

11. The method of claim 1, comprising:
rejecting a request for an unredacted version of the particular model element based on the particular model element being flagged for inclusion in a patent application that has not yet been filed.

12. The method of claim 1, wherein:
a security server performs said storing step, receiving step, and at least one of the facilitating delivery steps;
said facilitating delivery of the redacted version of the particular model element comprises the security server obtaining the redacted version from its own storage, and sending the redacted version to the user; and
said facilitating delivery of the unredacted version of the particular model element to the user comprises the security server obtaining the unredacted version from the first engineering team in response to the request, and sending the unredacted version to the user after it is received from the first engineering team.

13. A system for sharing a digital model, comprising:
a security server comprising processing circuitry operatively connected to memory and configured to:
storing in the memory at least metadata of a digital model of a system, wherein the digital model includes a plurality of discrete subsystems representing different functions of the system, each subsystem including a plurality of discrete model elements, and design responsibility for different ones of the model elements is assigned to different ones of a plurality of engineering teams;
receive, from a user that is not part of a first engineering team of the plurality of the engineering teams, a request to access a particular model element of a particular subsystem managed by the first of the engineering teams, wherein the particular model element includes at least one digital redaction implemented according to a security policy of the first of the engineering teams; and
perform at least one of:
based on the request lacking a redaction token corresponding to the at least one redaction, facilitate delivery of a redacted version of the particular model element to the user that includes the at least one redaction; and
based on the request including the redaction token, facilitate delivery of an unredacted version of the particular model element to the user.

14. The system of claim 13, wherein the processing circuitry is configured to:
utilize a token validation algorithm to determine whether the redaction token is valid or invalid; and
only facilitate delivery of the unredacted version of the particular model element if the token validation algorithm indicates that the redaction token is valid.

15. The system of claim 14, wherein the processing circuitry is configured to:
receive, from an administrative user associated with the first engineering team, an indication of a plurality of discrete redactions that correspond to different model elements of the particular subsystem; and
associate different redaction tokens with each of the discrete redactions.

16. The system of claim 13, wherein the processing circuitry is configured to receive a request from the user to access an additional model element of the particular subsystem that is non-redacted; and
facilitate delivery of the additional model element without requiring receipt of a redaction token.

17. The system of claim 13, wherein:
the first engineering team has one or more first security requirements and one or more second security requirements that differ from the one or more first security requirements;
compliance of the request with one or more first security requirements of the first engineering team is a prerequisite for the security server to facilitate delivery of the redacted version and the unredacted version of the particular model element; and
compliance of the request with one or more second security requirements of the first engineering team is a prerequisite for delivery of the unredacted version, but not the redacted version, of the particular model element.

18. The system of claim 17, wherein:
each of the engineering teams has a respective security client;
the processing circuitry is configured determine whether the request complies with the one or more first security requirements independently of the security client of the first engineering team; and
to facilitate delivery of the unredacted version of the particular model element, the processing circuitry is configured to send an indication of the request to the security client of the first engineering team for determination, by the security client of the first engineering team, of whether the request fulfills the one or more second security requirements.

19. The system of claim 17, wherein the first security requirements or second security requirements include at least one of:
a requirement that an IP address of a computing device that the request received from is not a blacklisted IP address;
a requirement that the computing device is not located in an unauthorized geographic territory;
a requirement that a static device identifier of the computing device is not blacklisted;
a requirement that the user is not part of a user group that the first engineering team has prohibited from accessing unredacted model elements of the first engineering team;
a requirement that the redaction token has not been used more than a predefined number of permitted times; and
a requirement that the particular model element is not flagged for inclusion in a patent application that has not yet been filed.

20. The system of claim 18, wherein, for each engineering team, the security client is configured to act as a broker by:
communicating with the server to send and receive requests for model elements;
communicating with the server to sending and receiving model elements; and
storing third party tokens for accessing redacted versions of model elements of others of the engineering teams.
